(19) United States
(12) Patent Application Publication
(10) Pub. No.: US 2010/0110978 A1
(43) Pub. Date: May 6, 2010

(54) IMS Device Reconfiguration

(75) Inventors: Jonas Falkenå, Huddinge (SE); Mats Stille, Bromma (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 12/444,797

(22) PCT Filed: Oct. 11, 2006
(86) PCT No.: PCT/SE2006/001151

§ 371 Date: Dec. 1, 2009

(51) Int. Cl. H04W 40/00; H04L 12/66

(52) U.S. Cl. 370/328; 370/352

(57) ABSTRACT

A method and arrangement in a telecommunication system for facilitating communications between a first terminal A configured to use a first session model and a second terminal B configured to use a second session model for media transportation. The first terminal A initiates a service capability check and in response, receives capability features of the second terminal B. Upon determining that the second terminal B uses the second session model, the first terminal A is reconfigured to use the second session model.

### TECHNICAL FIELD

The present invention relates to methods and arrangements in a telecommunication system to facilitate communication between a first terminal configured to use a first session model for media transportation, and a second terminal configured to use a second session model for the media transportation.

### BACKGROUND

IP Multimedia Subsystem IMS is the technology defined by the Third Generation Partnership Project 3GPP to provide IP Multimedia services over mobile communication networks (3GPP TS 22.228, TS 23.228, TS 24.229, TS 29.228, TS 29.229, TS 29.328 and TS 29.329 Release 5 and Release 6). IMS provides key features to enrich the end-user person-to-person communication experience through the use of standardized IMS Service Enablers, which facilitate new rich person-to-person (client-to-client) communication services as well as person-to-content (client-to-server) services over IP-based networks. The IMS makes use of the Session Initiation Protocol SIP to set up and control calls or sessions between user terminals (or user terminals and application servers). The Session Description Protocol SDP, carried by SIP signaling, is used to describe and negotiate the media components of the session. Whilst SIP was created as a user-to-user protocol, IMS allows operators and service providers to control user access to services and to charge users accordingly.

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalized, rich multimedia communication services, including so-called “combinational IP Multimedia” services.

The concept behind combinational services involves bundling the voice service in an existing circuit-switched CS domain with the “content” in the packet-switched PS domain. It uses standards-based voice and data networks that are, to a great extent, already in use by operators. An example of combinational services is when a voice call is setup as normal in the CS domain and then while the call is ongoing, content such as images, videos and files can be added or dropped via the PS domain. It enriches voice communication and improves the interaction between voice and data services creating a number of new business opportunities for mobile operators. The combinational services end-to-end solution is highly scalable, robust and aligned with the 3GPP Combining CS and IMS services CSI specifications and is based on IMS architecture as specified by 3GPP.

Fixed IMS deployments support a variety of services like IMS Multimedia Telephony MMtel, File Transfer and Instant Messaging etc. IMS Multimedia Telephony offers new, attractive services for the residential market. Operators can expand their current Public Switched Telephone Network PSTN offering with one or several IP-telephony lines to each household. IMS Multimedia Telephony is based on IMS standard, specified by 3GPP. Furthermore the solution is built according to a standardization conducted by TISPAN that handles additional requirements from fixed network perspective. IMS Multimedia Telephony reduces costs by allowing seamless adding of new applications and evolution of services from IP Telephony to Video telephony to fixed/mobile convergence. In IMS Multimedia Telephony, a single session model is used for multiple media transportation, e.g. voice and video is negotiated and setup as one signaling session. FIG. 1 is part of the prior art and schematically discloses communication between Multimedia Telephony terminals A1 and A2 both using media transfer according to a one-session model “ONE”. The further node entities shown in FIG. 1 will be explained later in the description when the invention is discussed.

Currently CSI (Combining CS and IMS services) is a 3GPP defined service used to enrich the experience of a normal mobile circuit switched CS communication session such as voice with a simultaneous IMS session. This IMS session could be a video stream, picture transfer or other types of media transfer.

While in IMS Multimedia Telephony MMtel, voice and video is negotiated and setup as one signaling session, in the case of CSI, voice is setup with a CS session and e.g. video is setup with an IMS session in parallel i.e. MMtel uses a one session model and CSI uses a two session model. Communication between terminals using different session models poses an interworking problem.

In the US Patent Application US 2006/0126590 is disclosed a method for receiving data in a system where data is transmitted on a plurality of frequencies. A device determines a configuration associated with a selected session and receives the session in accordance with a determined configuration. In a CSI to MMtel scenario the mismatch concerns a one-way session in relation to a two-way session where the second session could result in a busy response from the MMtel client.

A further problem is the necessity to do session re-routing. The US Patent Application US 2004/0160895 A1 discloses a failure notification followed by an appropriate re-routing.

A voice session initiation from MMtel to CSI will result in routing into the Packet Switched domain followed by a rejection from CSI, since CSI does not support Voice over Packet Switch, only Voice over Circuit Switch. MMtel uses the IMS domain for setup according to the one-session model while CSI uses both IMS and CS domains for setup according to the two-session model. Caller Preferences for the Session Initiation Protocol can be found in standard documents such as RFC 3841.

### SUMMARY

The present invention solves a problem related to communication between terminals using different session models. For a one-session-model terminal to be able to communicate with a two-session-model terminal, one session has to be split into two sessions or two sessions have to be merged into one. For example, in a CSI to MMtel scenario, if this is not done the second session could result in a busy or error response from the MMtel client. Splitting or merging sessions however implies obstacles due to the inherent differences of the session types. A further problem is the inability for an IMS Core network to do Circuit Switch breakout for a session aimed at a registered user. Breakout only occurs if the called subscribed is not registered within the system. In this case the subscriber is registered in the system but due to the communication incapability between a one-session-model terminal (such as MMtel) and a two-session-model terminal (such as CSI), no indication will be found in the IMS Control domain during session setup showing the necessity to perform routing in Circuit Switch domain for the two terminals to be able to communicate.

According to the invention, the communication problems are solved by facilitating for the one-session terminal circumstantially to select to communicate either according to a one-session-model or according to a two-session-model. Fetching registration data related to a terminating user permits the originating user to select what model type to use, i.e. in dependence of what model type the terminating user supports.

The solution to the problems more in detail comprises a method to facilitate communication in a telecommunication system, between a first terminal configured to use a first session model, and a second terminal configured to use a second session model for media transportation. The method comprises the following steps:
A service capability check is initiated from the first terminal.
Capability features related to the second terminal are received to the first terminal.
Establishment of the fact that the second terminal is configured to use the second session model.

The first terminal is reconfigured for usage of the second session model.

According to a further aspect of the invention the further problem is solved by performing a surrogate registration in the control domain in the telecommunication system. The surrogate registration enables routing into Circuit Switch domain.

An object of the invention is to enhance the ability for IMS/SIP clients such as an MMtel client to make enhanced voice calls to IMS/CS combined clients such as a CSI terminal. This object and others are achieved by methods, arrangement, systems and articles for manufacture.

An advantage with the invention is that it carries out a way to support interworking between fixed IMS/SIP one-session terminals and CSI two-session terminals.

Another advantage with the invention is that it introduces a surrogate registration function to enable the use of IMS functionality in the context of CSI interworking.

The invention will now be described more in detail with the aid of preferred embodiments in connection with the enclosed drawings.

### BRIEF DESCRIPTION OF THE DRAWINGS

FIG. 1 is part of prior art and discloses a block schematic illustration of IP Multimedia subsystem in conjunction with access networks and backbone network when media is transferred according to a one-session model.

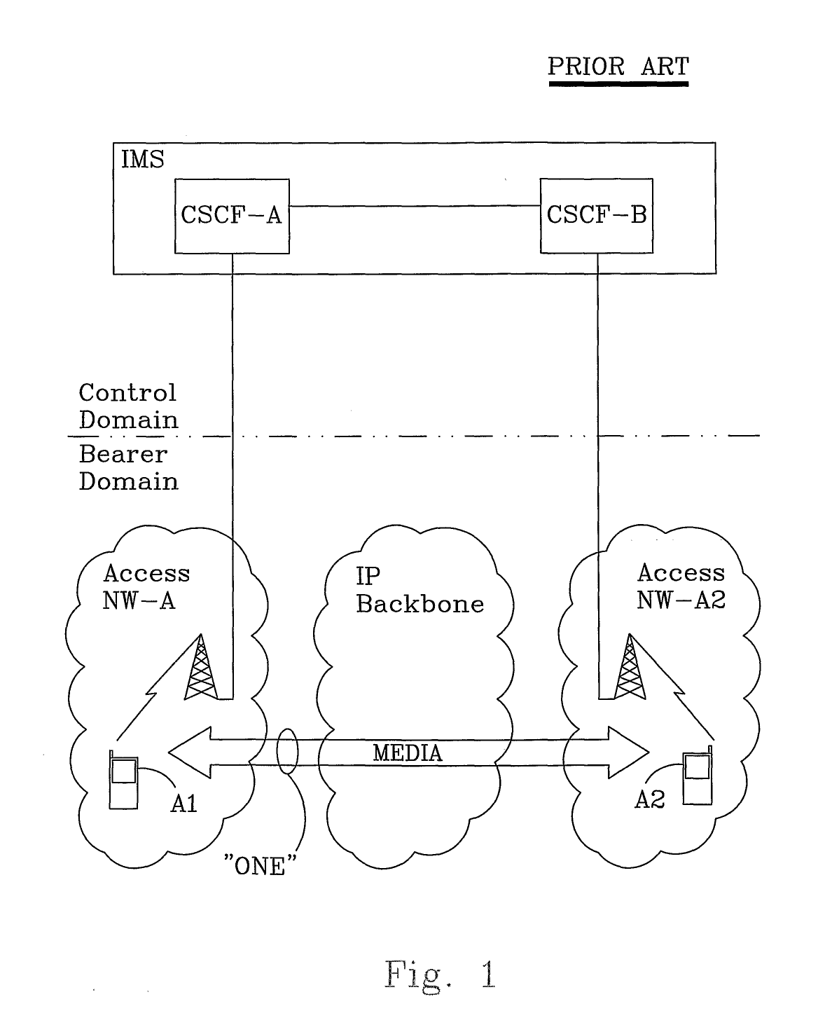

FIG. 2 discloses a block schematic illustration of IP Multimedia subsystem in conjunction with access networks and backbone network when media is transferred between a reconfigured MMtel terminal and a CSI terminal according to a two-session model. Voice and Video is initiated from the MMtel terminal.

FIG. 3 discloses a signal sequence diagram for voice call setup from MMtel to CSI followed by video initiation from MMtel.

FIG. 4 discloses a block schematic illustration of IP Multimedia subsystem in conjunction with access networks and backbone network when media is transferred between a reconfigured MMtel terminal and a CSI terminal according to a two-session model. Voice and Video is initiated from the CSI terminal.

FIG. 5 discloses a signal sequence diagram for voice call setup from CSI to MMtel followed by video initiation from CSI.

FIG. 6 discloses a flow chart illustrating some essential method steps of the invention.

FIG. 7 schematically discloses an arrangement that can be used to put the invention into practice.

### DETAILED DESCRIPTION

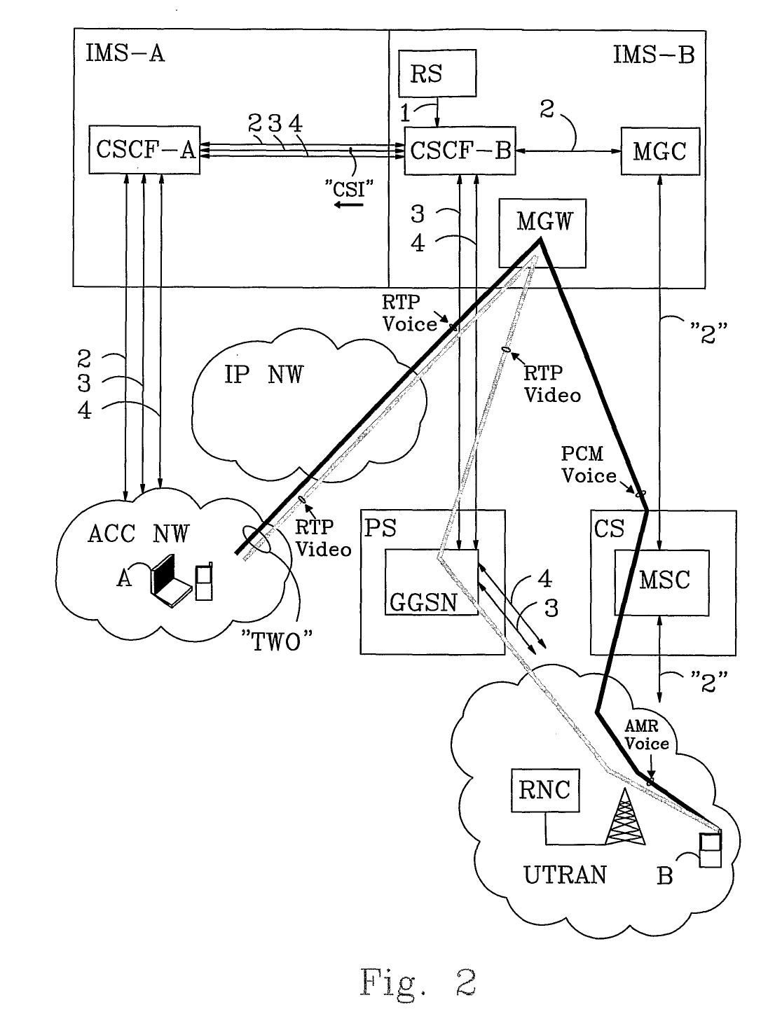

FIG. 2 discloses a telecommunication system comprising an IP Multimedia Subsystem IMS-A and IMS-B that handles signaling in a control domain. Media such as voice and video is mainly handled in a bearer domain. The bearer domain in the example consists of an access network ACC NW (such as PLMN and PSTN) and an UMTS Terrestrial Radio Access Network UTRAN and a backbone network IP NW. An MMtel client A is located in the access network ACC NW while a CSI client B is located in the access network UTRAN. The MMtel client A is a one-session client used for multiple media. Voice and video for example is negotiated and setup as one signaling session. According to the invention the MMtel device is re-configurable to select to communicate according to a one-session model or according to a two-session model. This re-configuration of the MMtel device will be further explained later in the description. The CSI client is a two-session client that communicates signaling and media to/from the IP Multimedia Subsystem IMS via a radio base station and a Radio Network Controller RNC. The signaling/media hereby pass a Mobile Service Switching Centre MSC in Circuit-Switched CS domain or a Gateway GPRS Support Node GGSN in Packet-Switched PS domain. The control domain in the example comprises two IMS networks, an originating network in this example IMS-A, and a terminating network IMS-B. In FIG. 2 each IMS network comprises a Call/Session Control Function CSCF-A and CSCF-B. The CSCFs are SIP servers and essential nodes in the IMS. A CSCF processes SIP signaling in the IMS network. The CSCF comprises different Call/Session Control Function types such as P-/I-/S-CSCF as defined in the standards but is for the sake of clarity shown in the schematic FIG. 2 as a single node. The P-CSCF acts among others as first point of contact (in the signaling plane) between a terminal and the IMS network, the S-CSCF is a central node of the signaling plane and performs session control. A Media Gateway Controller MGC receives the SIP signaling from the CSCF-B and transform the SIP signaling into ISDN User Part ISUP signaling. ISUP is used in Circuit Switched domain in the setting up, management, and release of trunks that carry voice and data between calling and called parties. A Registration Surrogate RS node registers a contact in CSCF-B. This contact contains information needed for the CSCF-B to route a request correctly. The RS is a SIP User Agent Client that performs a surrogate registration on behalf of a device such as a Circuit Switch device that can not register explicitly with the CSCF-B.

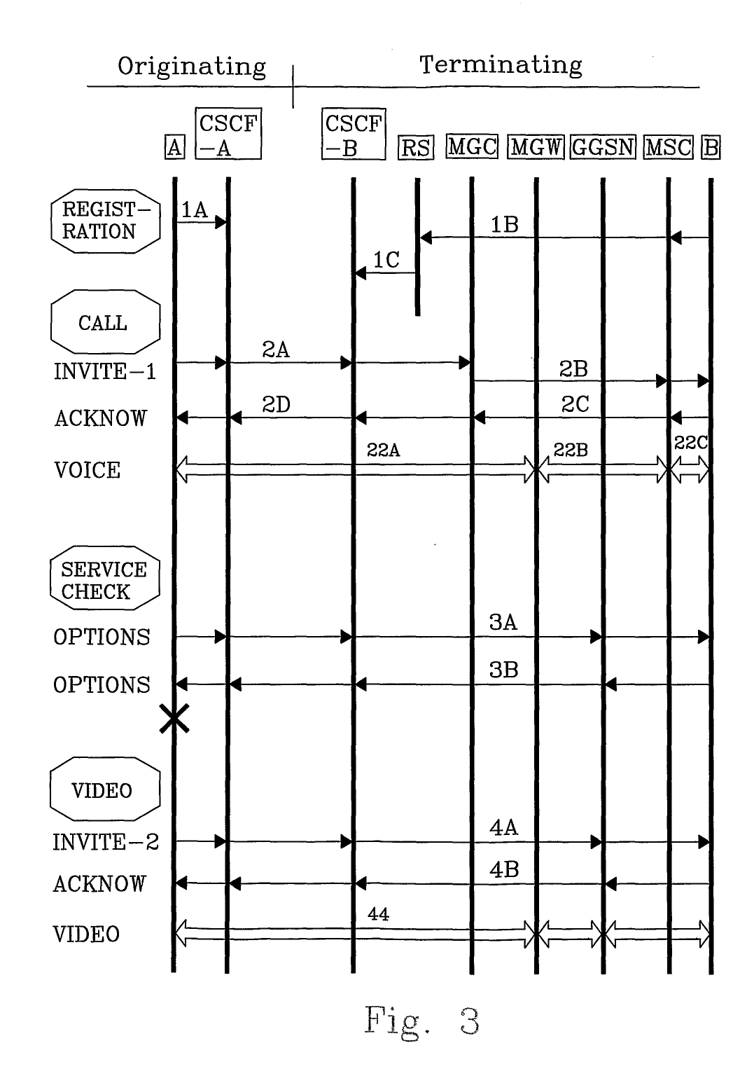

A first embodiment of the invention will now be introduced with FIG. 3. The method disclosed in FIG. 3 comprises voice call setup from A to B followed by A initiating video setup. The method will show a registration control that clarifies to the originating A client what session model the terminating B client uses i.e. a two-session model in this example. The method will also show routing of signaling into the CS domain and further setup of a voice/video in parallel in a two-session communication. A prerequisite for the invention is that the one-session A client is prepared to reconfigure to use also the two-session model and consequently explicitly has registered contact for both CSI and MMtel in CSCF-A FIG. 3 is divided into four signaling groups i.e. REGISTRATION, CALL, SERVICE CHECK and VIDEO. The node entities such as CSCF, RS, etc. have already been explained in FIG. 2. The method according to the first embodiment of the invention comprises the following steps:

Registration
A contact Tag=CSI&MMtel, a so called first feature tag, is stored in the CSCF-A as part of registration data for the A client. The contact is sent 1A from A to CSCF-A. The contact contains information needed for the CSCF-A to route any MMtel or CSI request to the A client.
The B client, i.e. the CSI client, attaches the Circuit Switched CS network and a signal 1B is sent via the MSC from B to the Registration Surrogate node RS.
The RS registers the A client, i.e. the MMtel client which is configurable to communicate using either the one- or two-session model. The registration is shown in the figure with a signal 1C. A contact Tag=MMtel, a so called second feature tag, is hereby stored in the CSCF-B as part of registration data for the B client. The registration can occur either dynamically, as in the step above, or statically, i.e. at provision. If dynamic registration is wanted this could be implemented using CAMEL triggers or OSA/Parlay/Parlay X Status Services. By static registration, the registration is set manually in the RS. The RS then e.g. periodically updates the CSCF-B. The contact contains information needed for the CSCF-B to route any MMtel request to the B device via the MGC and MSC in Circuit Switched domain.

Call
The A client initiates an MMtel voice session from the originating client A towards the terminating client B via CSCF-B, by sending a SIP INVITE request 2A. The CSCF-B finds the MMtel contact, i.e. the Tag=MMtel, for the mobile CSI device and routes the SIP signaling request 2A accordingly to the MGC. The MGC is a state machine that does protocol conversion and in this example the MGC maps SIP to ISUP. The MGC forwards the ISUP signaling request 2B via the MSC in Circuit Switched domain to the B client.
The B client responds with an acknowledgement by sending an acknowledge signal 2C via the MSC to the MGC. After conversion of 2C, a SIP 200 (OK) response signal 2D is sent from the MGC to the A client in accordance with FIG. 3.
A voice session is now established between the clients. The session consists of Real-Time Protocol RTP Voice 22A between the A client and the Media Gateway MGW, Pulse Code Modulation PCM Voice 22B between the MGW and the MSC and of Adaptive Multi Rate AMR Voice 22C between the MSC and the B client.

Service Check
A service capability check is performed using a SIP OPTIONS signal 3A sent from the A client via the Gateway GPRS Support Node GGSN in Packet Switched PS domain to the B client.
B client responds by sending a SIP OPTIONS signal 3B to the A client in accordance with FIG. 3. The SIP OPTIONS signal comprises a registration “CSI” showing that the B client supports CSI. In this case the remote B client only supports CSI, hence the originating A client knows to use the two session model for any additional media.
The A device is re-configured and is now prepared for usage of the second session model TWO. The reconfiguration is X-marked in FIG. 2. A prerequisite for the re-configuration is that the device is prepared to respond to the SIP OPTION signal above by the re-configuration.
Same kind of signaling as above is sent in opposite directions. During this signaling the B client asks the A client what signaling the A client supports and A answers. (this signaling is not shown in FIG. 3)

Video
The A client initiates a CSI Video session towards the B client by sending a SIP INVITE request 4A according to FIG. 3. The B client responds by sending a SIP 200 (OK) signal 4B to A.
A two-way video session is now established between the clients. The session consists of Real-Time Protocol RTP Video 44 between the clients A and B.

Initiation of the video session might as well come from the B client. To be noted is also that FIG. 3 only shows the general principles of the signaling. Of course the signaling will vary depending on the existing circumstances such as for example if IMS-A or IMS-B are acting as home or visited networks for the subscribers A and B respectively. Furthermore, the protocol type of the signaling is only mentioned briefly but can be found in standard related documents. To be noted is also that the tags (CSI and MMtel) mentioned above are to be seen as examples. Any feature tag could be used.

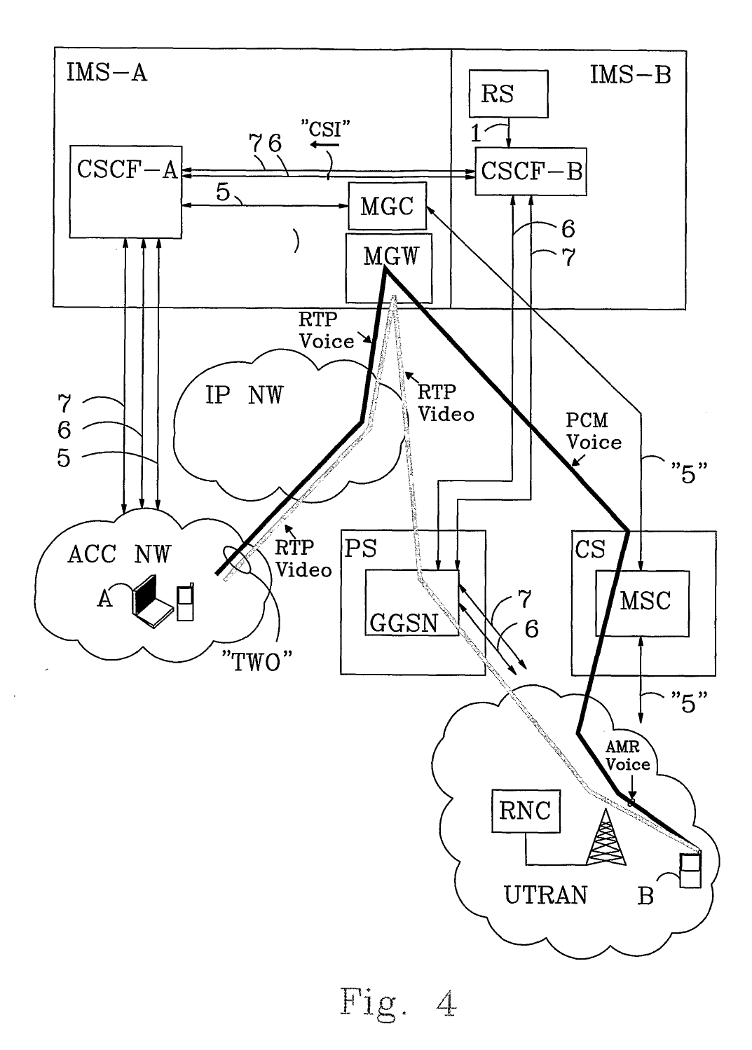

FIG. 4 corresponds in general to the already explained FIG. 2. However, in FIG. 4 IMS-B is the originating IMS network and IMS-A is the terminating network. A Media GateWay MGW and a Media Gateway Controller used in the invention are in the second embodiment located in IMS-A instead of IMS-B as in the first embodiment.

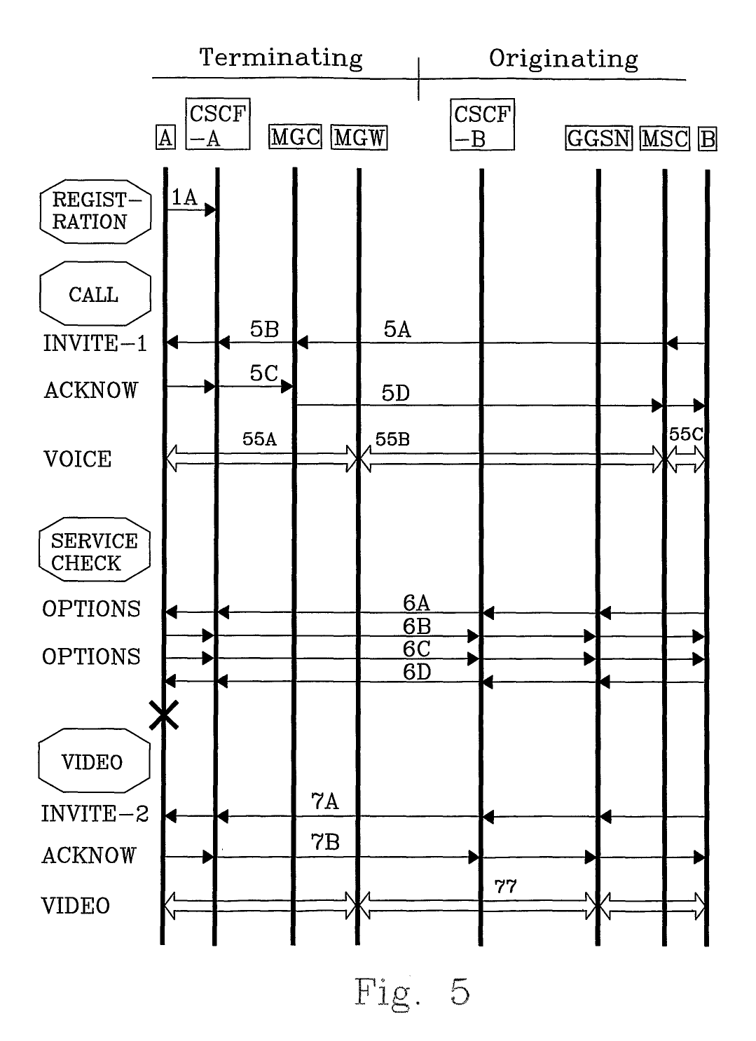

FIG. 5 discloses a second embodiment of the invention The method disclosed in FIG. 5 comprises voice call setup from B to A followed by B initiating video setup. In this case IMS-B is the originating IMS network while IMS-A is the terminating network. The method will like in the first embodiment show setup of a voice/video in parallel in a two-session communication. The method according to the second embodiment of the invention comprises the following steps:

Registration
Registration is performed in the same manner as in the first embodiment i.e. a contact Tag=CSI&MMtel is stored in the CSCF-A.

Call
The B client initiates a CSI voice session from the originating B client towards the terminating A client via the MGC located in the terminating network IMS-A to CSCF-A by sending a SETUP signal 5A. The MGC transforms the ISUP signaling into SIP signaling. The CSCF-A finds the CSI contact, i.e. the Tag=CSI&MMtel and forwards a SIP signaling request 5B accordingly from MGC to the A client.
The A client responds with an acknowledgement by sending an acknowledge signal 5C i.e a SIP 200 (OK) response signal via the MGC. After conversion of 5C, an ISUP acknowledgement signal 5D is sent from the MGC to the MSC in the originating network in accordance with FIG. 5.
A voice session is now established between the clients. The session consists of Real-Time Protocol RTP Voice 55A between the A client and the Media Gateway MGW, Pulse Code Modulation PCM Voice 55B between the MGW and the MSC and of Adaptive Multi Rate AMR Voice between the MSC and the B client.

Service Check
A service capability check is performed using a SIP OPTIONS signal 6A sent from the B client via the Gateway GPRS Support Node GGSN in Packet Switched PS domain to the A client.
The A client responds by sending a SIP OPTIONS signal 6B to the B client. The SIP OPTIONS signal comprises a registration “MMtel” (not shown in the figures) showing that the A client supports MMtel.
A service capability check is performed using a SIP OPTIONS signal 6C sent from the A client via the Gateway GPRS Support Node GGSN in Packet Switched PS domain to the B client.
The B client responds by sending a SIP OPTIONS signal 6D to the A client. The SIP OPTIONS signal comprises a registration “CSI” (see FIG. 4) showing that the B client supports CSI. In this case the remote B client only supports CSI, hence the originating A client knows to use the two session model for any additional media.
The A device is re-configured and is now prepared for usage of the second session model TWO. The reconfiguration is X-marked in FIG. 2.

Video
The B client initiates a CSI Video session towards the A client by sending a SIP INVITE request 7A.
A two-way video session is now established between the clients. The session consists of Real-Time Protocol RTP Video 77 between the clients A and B.

Initiation of the video session might as well come from the A client. This has already been shown in the first embodiment.

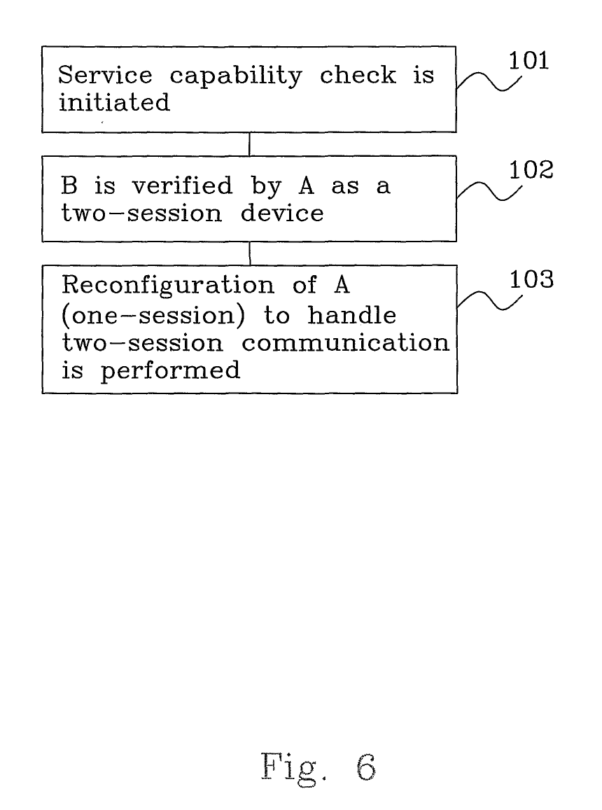

FIG. 6 discloses a flowchart in which some important steps are shown. The flowchart is to be read together with the earlier shown figures. The flowchart comprises the following steps:
A service capability check is initiated and sent from the first terminal A to the second terminal B. This step is shown in FIG. 6 with a block 101.
Capability features “CSI” related to the second terminal B is received to A. The first terminal A establishes that B is configured to use a second session model. This step is shown in FIG. 6 with a block 102.
The first terminal A is reconfigured to use the same session model as B i.e. the second session model. This step is shown in FIG. 6 with a block 103.

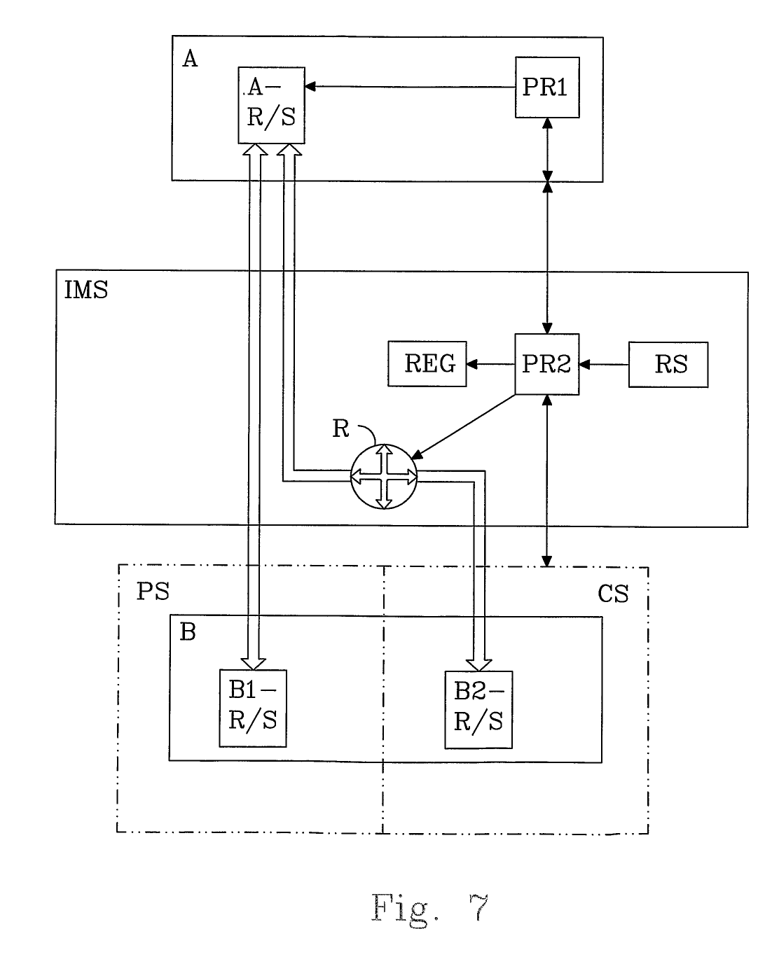

An arrangement that can be used to put the invention into practice is schematically shown in FIG. 7. FIG. 7 discloses a network IMS and user devices A and B. User device A corresponds to the earlier described A client and user device B corresponds to the earlier described B client. The user device A comprises a processor unit PR1 that receives, handles and send signals such as registration and media setup signals to IMS and B. PR1 includes capability to receive and respond to an option signal and reconfigure a receiver/sending device A-R/S to receive/send media according to the one-session or two-session model. A processor unit PR2 in the IMS network handles registration and media setup. A registration unit REG in the IMS network receives registration data from A, B or from a Registration Surrogate device RS via the processor unit PR2. The registration data is stored in REG. A routing device R is responsible for routing via the Circuit Switched domain CS. B operates in Packet Switched PS domain and Circuit Switched CS domain. B receives/sends media in PS domain via a Receiver/Sender B1-R/S and receives/sends media in CS domain via a Receiver/Sender B2-R/S.

In the figures enumerated items are shown as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The invention is not limited to the above shown examples. Various kinds of networks types can be used by the invention such as PSTN, PLMN etc. The IMS configuration can, as already indicated, be of various kinds. To be noted is also that the tags (CSI and MMtel) mentioned in this document are to be seen as examples. Any feature tag could be used. The invention is of course not limited to the above described and in the drawings shown embodiments but can be modified within the scope of the enclosed claims.

1-23. (canceled)

24. A method in a telecommunication system of facilitating communication between a first terminal (A) configured to use a first session model (ONE) wherein two media sessions are negotiated and set up as one signaling session, and a second terminal (B) configured to use a second session model (TWO) wherein two media sessions are set up in parallel as two signaling sessions for media transportation, said method comprising the steps of:
initiating a service capability check from the first terminal (A);
receiving at the first terminal (A), capability features (CSI) related to the second terminal (B);
determining that the second terminal (B) only supports the second session model (TWO); and
selecting by the first terminal (A) to communicate according to the second session model (TWO) in response to determining that the second terminal (B) only supports the second session model (TWO).

25. The method according to claim 24, further comprising registering a first feature tag (CSI&MMtel) in a control domain in the system, the first feature tag representing a contact between the first terminal (A) and the second terminal (B).

26. The method according to claim 24, further comprising the steps of:
registering a second feature tag (MMtel) in a control domain in the system, the second feature tag representing a contact between the first terminal (A) and the second terminal (B);
initiating setup of a first media session (Voice) between the first terminal A and the second terminal B;
detecting the registered first tag (MMtel); and
routing the first media session via a circuit-switched domain.

27. The method according to claim 26, wherein the registering step includes registering the second feature tag (MMtel) either statically or dynamically via a Surrogate Register (RS).

28. The method according to claim 27, wherein the registering step includes registering the second feature tag (MMtel) statically by manual input to the Surrogate Register (RS).

29. The method according to claim 27, wherein the registering step includes registering the second feature tag dynamically by input of the tag (MMtel) to the Surrogate Register (RS) when the second terminal (B) enters into the system.

30. The method according to claim 29, wherein the registering step includes registering the second feature tag dynamically by implementing CAMEL triggers or OSA/Parlay/Parlay X Status Services.

31. The method according to claim 26, further comprising initiating setup of a second media session (Video) in a packet-switched domain between the first terminal A and the second terminal B in parallel with the first session (Voice).

32. The method according to claim 25, wherein the registering step includes registering the first feature tag (MMtel&CSI) in a Call/Session Control Function (CSCF-A) in which user data for the first terminal (A) is stored.

33. The method according to claim 26, wherein the registering step includes registering the second feature tag (MMtel) in a Call/Session Control Function (CSCF-B) in which user data for the second terminal (B) is stored.

34. The method according to claim 24, wherein the first terminal (A) is prepared to communicate by using the first session model (ONE) or the second session model (TWO).

35. An arrangement in a telecommunication system for facilitating communications between a first terminal (A) configured to use a first session model (ONE) wherein two media sessions are negotiated and set up as one signaling session, and a second terminal (B) configured to use a second session model (TWO) wherein two media sessions are set up in parallel as two signaling sessions for media transportation, said arrangement comprising:
means in the first terminal (A) for initiating a service capability check;
means for receiving in the first terminal (A), capability features (CSI) related to the second terminal (B);
means in the first terminal (A) for determining that the second terminal (B) only supports the second session model (TWO); and
means in the first terminal (A) for selecting to communicate according to the second session model (TWO) in response to determining that the second terminal (B) only supports the second session model (TWO).

36. The arrangement according to claim 35, further comprising means for registering a first feature tag (CSI&MMtel) in a control domain in the system, the first feature tag representing a contact between the first terminal (A) and the second terminal (B).

37. The arrangement according to claim 35, further comprising:
means for registering a second feature tag (MMtel) in a control domain in the system, the second feature tag representing a contact between the first terminal (A) and the second terminal (B);
means for initiating setup of a first media session (Voice) between the first terminal A and the second terminal B;
means for detecting the registered first tag (MMtel); and
means for routing the first media session via a circuit-switched domain.

38. The arrangement according to claim 37, wherein the second tag (MMtel) is registered either statically or dynamically via a Surrogate Register (RS).

39. The arrangement according to claim 38, wherein the second tag (MMtel) is registered statically by manual input to the Surrogate Register (RS).

40. The arrangement according to claim 38, wherein the second tag is registered dynamically by input of the tag (MMtel) to the Surrogate Register (RS) when the second terminal (B) enters into the system.

41. The arrangement according to claim 40, wherein the second tag is registered dynamically by implementing CAMEL triggers or OSA/Parlay/Parlay X Status Services.

42. The arrangement according to claim 37, further comprising means for initiating setup of a second media session (Video) in a packet-switched domain between the first terminal A and the second terminal B in parallel with the first session (Voice).

43. The arrangement according to claim 36, further comprising means for registering the first feature tag (MMtel&CSI) in a Call/Session Control Function (CSCF-A) in which user data for the first terminal (A) is stored.

44. The arrangement according to claim 37, further comprising means for registering the second feature tag (MMtel) in a Call/Session Control Function (CSCF-B) in which user data for the second terminal (B) is stored.

45. A system in a telecommunication network for facilitating communications between a first terminal (A) configured to use a first session model (ONE) wherein two media sessions are negotiated and set up as one signaling session, and a second terminal (B) configured to use a second session model (TWO) wherein two media sessions are set up in parallel as two signaling sessions for media transportation, said system comprising:
means for registering in a control domain in the system, mutual communication possibilities between the first terminal (A) and the second terminal (B);
means for initiating setup of a first media session (Voice) between the first terminal (A) and the second terminal (B);
means for routing the first media session via a circuit-switched domain;
means in the first terminal (A) for determining that the second terminal (B) only supports the second session model (TWO);
means in the first terminal (A) for selecting to communicate according to the second session model (TWO) in response to determining that the second terminal (B) only supports the second session model (TWO); and
means for initiating setup of a second media session (Video) between the first terminal (A) and the second terminal (B) in parallel with the first session (Voice).

46. An article of manufacture in a telecommunication system for facilitating communications between a first terminal (A) configured to use a first session model (ONE) wherein two media sessions are negotiated and set up as one signaling session, and a second terminal (B) configured to use a second session model (TWO) wherein two media sessions are set up in parallel as two signaling sessions for media transportation, said article of manufacture comprising:
a control processor; and
computer readable program code which, when run on the processor, causes the processor to perform the steps of:
initiating from the first terminal (A), a service capability check;
receiving by the first terminal (A), capability features (CSI) related to the second terminal (B);
determining that the second terminal (B) only supports the second session model (TWO); and
selecting by the first terminal (A), to communicate according to the second session model (TWO) in response to determining that the second terminal (B) only supports the second session model (TWO).
